(19) United States
(12) Patent Application Publication
(10) Pub. No.: US 2017/0201936 A1
(43) Pub. Date: Jul. 13, 2017

(54) Method and Device for Controlling Network Connection

(71) Applicant: ZTE CORPORATION, Shenzhen City, Guangdong Province (CN)

(72) Inventors: Shaoxian FU, Shenzhen (CN); Xiangqian WANG, Shenzhen (CN)

(21) Appl. No.: 15/313,539

(22) PCT Filed: Aug. 19, 2014
(86) PCT No.: PCT/CN2014/084737

§ 371 Date: Nov. 22, 2016

(30) Foreign Application Priority Data
May 23, 2014 (CN) 201410222284.9

(51) Int. Cl. H04W 48/18; H04W 24/08; H04W 24/02; H04L 12/26

(52) U.S. Cl. CPC H04W 48/18; H04L 43/16; H04W 24/08; H04W 24/02

(57) ABSTRACT

The embodiments of the present document provide a method for controlling data transmission. The method includes: setting a threshold, herein the threshold is a network rate threshold; in a case that at least two networks are simultaneously connected, detecting a network rate of data transmission performed by each network in real time; comparing the detected network rate with the threshold as a reference basis to obtain a comparison result; and selecting a target network from the at least two networks according to the comparison result and performing data transmission.

### TECHNICAL FIELD

The present document relates to the field of mobile communication technology, and in particular, to a method and device for controlling a network connection.

### BACKGROUND OF THE RELATED ART

At least the following technical problems are found in related art by the inventor of this application during the implementation of the technical scheme of the embodiments of the present application:

With the popularization of mobile terminals especially smartphones and the increase of the Wi-Fi network coverage range, when performing data transmission, the user can select a number of different network connection modes such as a data connection and a Wi-Fi connection to perform data transmission. The existing scheme for controlling the network connection is: the Wi-Fi connection is performed by default in a case that the Wi-Fi connection and the data connection of a user terminal are simultaneously opened to access a Wi-Fi network and maintain the Wi-Fi network connection, and only when a Wi-Fi signal is not detected, it will switch to the data connection, and data transmission is performed through the data connection, otherwise, the Wi-Fi network connection mode will be adopted all the time, which is not optional.

The problem existing in the above scheme is that: in a case of accessing the Wi-Fi network and maintaining the Wi-Fi network connection, the Wi-Fi signal may be very poor, and cannot provide a better network service to the user, in order to obtain a better network service, the user has a selection requirement for switching to other network connection modes, for example, a requirement for automatically selecting to switch to the data connection to perform data transmission. However, with regard to this problem, no effective solution exists in the related art.

### SUMMARY

In view of this, the embodiments of the present document are desired to provide a method and device for controlling a network connection, which can automatically select a network connection for performing data transmission between different network connections according to the actual network data transmission rate.

In order to achieve the above objects, the technical scheme of the embodiments of the present document is implemented as follows:

The embodiment of the present document provides a method for controlling data transmission, the method includes: setting a threshold, herein the threshold is a network rate threshold; in a case that at least two networks are simultaneously connected, detecting a network rate of data transmission performed by each network in real time; comparing the detected network rate with the threshold as a reference basis to obtain a comparison result; and selecting a target network from the at least two networks according to the comparison result and performing data transmission.

In the above scheme, selecting a target network from the at least two networks according to the comparison result and performing data transmission includes: when there are two networks, acquiring a first rate corresponding to a first network and a second rate corresponding to a second network; and when the second rate is less than the threshold and the second rate is less than the first rate, selecting the first network to perform data transmission.

In the above scheme, selecting a target network from the at least two networks according to the comparison result and performing data transmission further includes: when the second rate is not less than the threshold or the second rate is not less than the first rate, selecting the second network to perform data transmission.

In the above scheme, the method further includes: after selecting the first network to perform data transmission, when the second rate is not less than the threshold or the second rate is not less than the first rate, switching to the second network for the second network to perform data transmission.

In the above scheme, the method further includes: after selecting the second network to perform data transmission, when the second rate is less than the threshold and the second rate is less than the first rate, switching to the first network for the first network to perform data transmission.

The embodiment of the present document further provides a device for controlling data transmission, the device includes a setting module, a detection module and a selection module; herein, the setting module is configured to set a threshold, herein the threshold is a network rate threshold; the detection module is configured to, in a case that at least two networks are simultaneously connected, detect a network rate of data transmission performed by each network in real time; and the selection module is configured to compare the detected network rate with the threshold as a reference basis to obtain a comparison result; and select a target network from the at least two networks according to the comparison result and perform data transmission.

In the above scheme, a detection submodule is configured to, when there are two networks, acquire a first rate corresponding to a first network and a second rate corresponding to a second network; correspondingly, the selection module includes a first selection submodule configured to, when the second rate is less than the threshold and the second rate is less than the first rate, select the first network to perform data transmission.

In the above scheme, the selection module further includes a second selection submodule configured to, when the second rate is not less than the threshold or the second rate is not less than the first rate, select the second network to perform data transmission.

In the above scheme, the device further includes a first switching module configured to, after selecting the first network to perform data transmission, when the second rate is not less than the threshold or the second rate is not less than the first rate, switch to the second network for the second network to perform data transmission.

In the above scheme, the device further includes a second switching module configured to, after selecting the second network to perform data transmission, when the second rate is less than the threshold and the second rate is less than the first rate, switch to the first network for the first network to perform data transmission.

The setting module, the detection module, the selection module, the detection submodule, the first selection submodule, the second selection submodule, the first switching module and the second switching module can be implemented by using a Central Processing Unit (CPU), a Digital Signal Processor (DSP) or a Field-Programmable Gate Array (FPGA) when the processing is executed.

The embodiment of the present document provides a method for controlling a network connection, in the method, a threshold is set and the threshold is a network rate threshold; in a case where at least two networks are simultaneously connected, a network rate of data transmission performed by each network is detected in real time; the detected network rate is compared with the threshold as a reference basis to obtain a comparison result; and a target network is selected from the at least two networks according to the comparison result and data transmission is performed; thus a network connection for performing data transmission is automatically selected with the existing data resources, which improves the users' data service experience.

### BRIEF DESCRIPTION OF DRAWINGS

FIG. 1 is a schematic diagram of a flow of a method for controlling a network connection according to an embodiment of the present document;

FIG. 2 is a schematic diagram of a flow of the method for controlling the network connection according to one specific application example of the present document;

FIG. 3 is a schematic diagram of a flow of the method for controlling the network connection according to another specific application example of the present document; and

FIG. 4 is a schematic diagram of a structure of a device for controlling a network connection according to an embodiment of the present document.

### SPECIFIC EMBODIMENTS

In an embodiment of the present document, a threshold is set and the threshold is a network rate threshold; in a case where at least two networks are simultaneously connected, a network rate of data transmission performed by each network is detected in real time; the detected network rate is compared with the threshold as a reference basis to obtain a comparison result; and a target network is selected from the at least two networks according to the comparison result and data transmission is performed.

The present document will be further described in detail through the accompanying drawings and specific embodiments below.

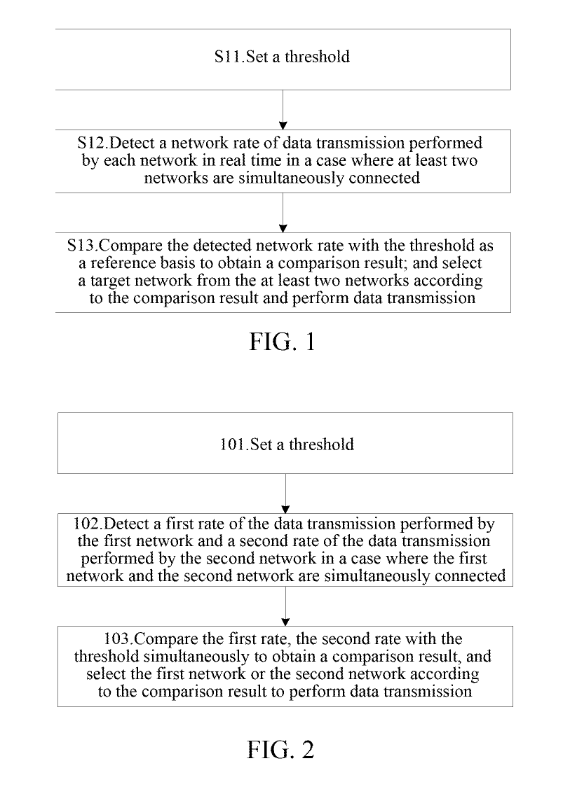

As shown in FIG. 1, a method for controlling a network connection provided by an embodiment of the present document includes the following steps.

In step S11, a threshold is set; here, the threshold is a network rate threshold.

In step S12, a network rate of data transmission performed by each network is detected in real time in a case where at least two networks are simultaneously connected.

In step S13, the detected network rate is compared with the threshold as a reference basis to obtain a comparison result; and a target network is selected from the at least two networks according to the comparison result and data transmission is performed.

In S13, selecting a target network from the at least two networks according to the comparison result and performing data transmission includes: when there are two networks, acquiring a first rate corresponding to a first network and a second rate corresponding to a second network; selecting the first network to perform data transmission when the second rate is less than the threshold and the second rate is less than the first rate; and here, after selecting the first network to perform data transmission, when the second rate is not less than the threshold or the second rate is not less than the first rate, switching to the second network for the second network to perform data transmission.

Selecting a target network from the at least two networks according to the comparison result and performing data transmission also includes: selecting the second network to perform data transmission when the second rate is not less than the threshold or the second rate is not less than the first rate; and here, after selecting the second network to perform data transmission, when the second rate is less than the threshold and the second rate is less than the first rate, switching to the first network for the first network to perform data transmission.

In FIG. 2, the method for controlling the network connection provided by an embodiment of the present document is elaborated with an example of a connection scenario that two networks exist, and the following steps are specifically included.

In step 101, a threshold is set.

Specifically, a mobile terminal presets a threshold, and the setting of the threshold includes: detecting a data transmission rate of the current network environment, and obtaining the threshold according to the data transmission rate; herein, the data transmission rate includes a first rate and/or a second rate.

Here, when detecting the data transmission rate of the current network environment, the mobile terminal is not required to judge whether the network connection for performing data transmission is a first network or a second network, it only pays attention to the data transmission rate of the data services performed by the mobile terminal itself, and the threshold is determined according to the data transmission rate, herein, the first network may be a 2G/3G/LTE network, and the second network may be a WI-FI network.

In step 102, a first rate of data transmission performed by the first network and a second rate of data transmission performed by the second network are detected in real time in a case where the first network and the second network are simultaneously connected.

Specifically, in a case where the mobile terminal is simultaneously connected with the first network and the second network, the first network and the second network are respectively detected, and the rate of the data transmission performed by the first network and the rate of the data transmission performed by the second network are acquired, here, the mobile terminal does not perform data transmission, and a first rate for the first network to perform data transmission when not performing data transmission and a second rate for the second network to perform data transmission when not performing data transmission can be detected through system services.

In practical applications, a user terminal acquires data transmission rate of various networks through system services, sends a specific data packet request to a network of which the data transmission rate needs to be detected by using the system services, and calculates the data transmission rate of the network through a relation between a size of the received data packet and a consumed time; and the destination addresses of the data packet requests are different in the process of detecting the data transmission rate, thus the data transmission rates of the first network and the second network are simultaneously detected.

In step 103, the first rate and the second rate are simultaneously compared with the threshold to obtain a comparison result, and the first network or the second network is selected to perform data transmission according to the comparison result.

Specifically, simultaneously comparing the first rate and the second rate with the threshold to obtain a comparison result includes the following two cases:

case 1: the second rate is less than the threshold and the second rate is less than the first rate;

case 2: the second rate is not less than the threshold or the second rate is not less than the first rate.

When the comparison result is the case 1, the mobile terminal selects the first network to perform data transmission; and

when the comparison result is the case 2, the mobile terminal selects the second network to perform data transmission.

Here, when selecting the first network or the second network to perform data transmission, the mobile terminal continues to detect the first rate corresponding to the first network and the second rate corresponding to the second network, and judges whether to maintain the existing network connection or switch to another network connection according to the acquired first rate and the second rate.

Specifically, after selecting the first network to perform data transmission, when the case 2 is met, that is, when the second rate is not less than the threshold or the second rate is not less than the first rate, the switching is performed from the first network to the second network and the data transmission is performed by the second network.

After selecting the second network to perform data transmission, when the case 1 is met, that is, when the second rate is less than the threshold and the second rate is less than the first rate, the switching is performed from the second network to the first network and the data transmission is performed by the first network.

In practical applications, when the user terminal switches from the first network to the second network or from the second network to the first network, the broken data transmission may be continuously transmitted by means of breakpoint continuous transmission, specifically, with respect to one data service, another network is used to continue to upload or download the unfinished part starting from the part that has been uploaded or downloaded by one network, and it is not required to restart uploading or downloading the ongoing data service, which improves the speed of the data service; meanwhile, when there is data to be transmitted, the data transmission rate may be detected by means of breakpoint continuous transmission.

Therefore, in consideration of the difference between different network connections, a technical scheme is required, which can automatically select a network connection for performing data transmission between different network connections according to the actual network data transmission rate, thereby providing better network services to the user, and meeting a selection requirement of the user to switch to another network connection mode.

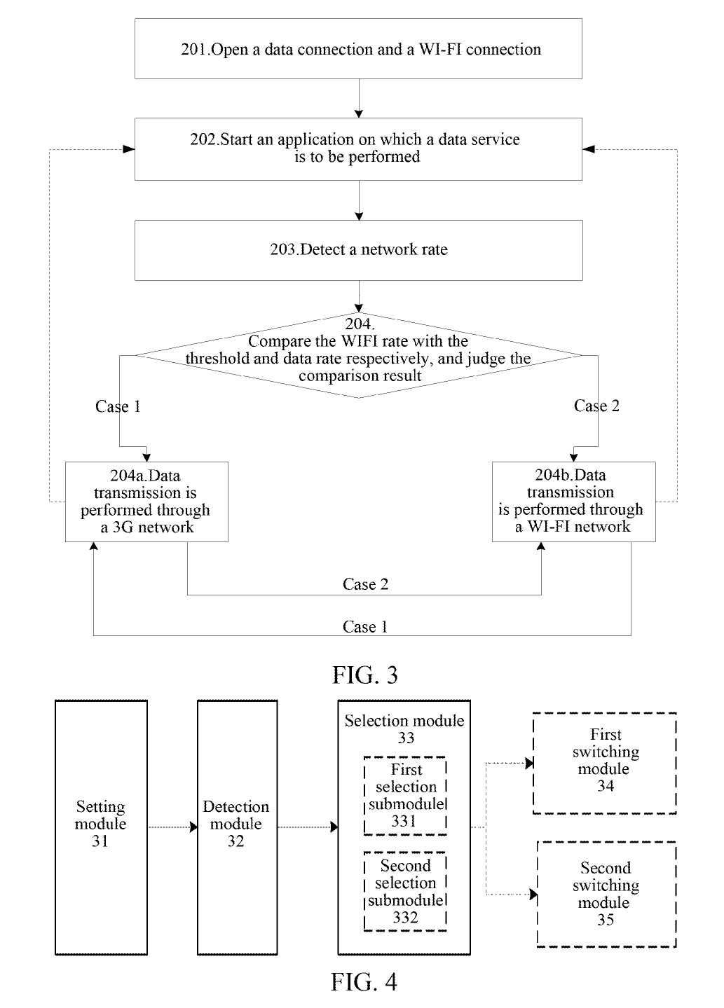

FIG. 3 is another specific application of the embodiment of the present document, here the method for controlling the network connection according to an embodiment of the present document is elaborated with an example of the first network being a 3G network and the second network being a WI-FI network, and as shown in FIG. 3, the following steps are included.

In step 201, a data connection and a WI-FI connection are opened.

Here, the data connection is a network connection of the 3G network, and the WI-FI connection is a network connection of the WI-FI network; the data connection and the WI-FI connection are simultaneously opened, herein, they may be opened when the mobile terminal powers on or when there is a network connection request, and the way of opening may be manual opening by the user or automatic opening through a control application open software. Here, the control application is a controlled application with a function of controlling the data connection and the Wi-Fi connection, such as a mobile phone assistant.

In step 202, an application on which a data service is to be performed is started.

At this point, an application on which a data service is to be performed on the mobile terminal is started, and the application needs to perform the data services over the data connection or the WI-FI connection; applications here are all applications that are located on the user terminal with data transmission requirement.

In step 203, a network rate is detected.

Here, the detected network rates include a data rate of the 3G network and a WI-FI rate of the WI-FI network, an average value of data transmission rates detected within 30 seconds is calculated to obtain an average rate, and the average rate is multiplied by a weight value of one half to obtain a threshold, herein, the data transmission rate is a data transmission rate of the data service performed by the mobile terminal itself, and the threshold is determined according to the data transmission rate.

In practical applications, the calculation of the average rate may be selected as a average value within a time period from 30 seconds to 2 minutes, and the weight value of the average rate may also be other numerical values other than one half, which is not limited in the embodiment of the present document.

In step 204, the WI-FI rate is compared with the threshold and the data rate respectively, and a comparison result is judged.

Here, after the threshold is determined, the detected WI-FI rate is compared with the determined threshold and the data rate respectively, when the comparison result meets the case 1, that is, the WI-FI rate is less than the threshold and the WI-FI rate is less than the data rate, step 204a is performed, and the data transmission is performed through the data connection; and when the comparison result meets the case 2, that is, the WI-FI rate is not less than the threshold or the WI-FI rate is not less than the data rate, step 204b is performed, and the data transmission is performed through the WI-FI connection.

In step 204a, the data transmission is performed through a 3G network.

At this point, the mobile terminal performs data transmission through the data connection in the connected 3G network and the WI-FI network; the mobile terminal detects a transmission rate of the WI-FI network while performing data transmission through the 3G network, and compares the data rate of the 3G network in which data transmission is performed, the WI-FI rate of the WI-FI network in which data transmission is not performed with the determined threshold, when the WI-FI rate is less than the threshold and the WI-FI rate is less than the data rate, maintains the current data connection; and when the WI-FI rate is not less than the threshold or the WI-FI rate is not less than the data rate, switches to the WI-FI connection.

In step 204b, the data transmission is performed through a WI-FI network.

At this point, the mobile terminal performs data transmission through the WI-FI connection in the connected 3G network and the WI-FI network, the mobile terminal detects a transmission rate of the 3G network while performing data transmission through the WI-FI network, and compares the WI-FI rate of the WI-FI network in which data transmission is performed, the data rate of the 3G network in which data transmission is not performed with the determined threshold, when the WI-FI rate is not less than the threshold or the WI-FI rate is not less than the data rate, maintains the current WI-FI connection; and when the WI-FI rate is less than the threshold and the WI-FI rate is less than the data rate, switches to the data connection.

In practical applications, as shown by dotted lines in FIG. 3, when an application is closed, the mobile terminal does not close the data connection or the Wi-Fi connection, but when a new application is started, controls the network connection again through the process shown in step 202 to step 204a or step 204b to select an appropriate network connection for performing data transmission.

In practical applications, when selecting a network connection for performing data transmission, if a data transmission speed of the Wi-Fi network is greater than the threshold, a mobile device performs related operations of the Wi-Fi network connection, and compares a data transmission speed of the current Wi-Fi network with a data transmission speed of the current 3G network.

If the data transmission speed of the current Wi-Fi network is greater than or equal to the data transmission speed of the current 3G network, the mobile device maintains the current network connection of the Wi-Fi network; if the data transmission speed of the current Wi-Fi network is less than the data transmission speed of the current data service network but greater than the threshold, the mobile device maintains the current network connection of the Wi-Fi network; and if the data transmission speed of the current Wi-Fi network is less than the data transmission speed of the current 3G network and is not greater than the threshold, the mobile device selects the 3G network to perform related operations of the data service.

It should be noted that, a basis for judging whether to perform data transmission through the first network or to perform data transmission through the second network in the embodiment of the present document, namely that the comparison result between the first rate, the second rate and the threshold is divided into two cases (case 1 and case 2) is based on the principle of preferentially selecting the second network, and when the second network is the Wi-Fi network, the mobile terminal can better satisfy the data transmission of large flow of data.

In order to implement the above method, the embodiment of the present document further provides a device for controlling a network connection, and as shown in FIG. 4, the device includes: a setting module 31, a detection module 32 and a selection module 33.

The setting module 31 is configured to set a threshold, herein the threshold is a network rate threshold.

The detection module 32 is configured to detect a network rate of data transmission performed by each network in real time in the case where at least two networks are simultaneously connected; herein, in the case where at least two networks are simultaneously connected, the network rate of data transmission performed by each network is detected in real time.

The selection module 33 is configured to compare the detected network rate with the threshold as a reference basis to obtain a comparison result; and select a target network from the at least two networks according to the comparison result and perform data transmission.

The selection module 33 includes: a first selection submodule 331 and a second selection submodule 332; herein, the first selection submodule 331 is configured to select the first network to perform data transmission when the second rate is less than the threshold and the second rate is less than the first rate; and the second selection submodule 332 is configured to select the second network to perform data transmission when the second rate is not less than the threshold or the second rate is not less than the first rate.

As shown in FIG. 4, the device further includes a first switching module 34 and a second switching module 35, herein, the first switching module 34 is configured to, after selecting the first network to perform data transmission, when the second rate is not less than the threshold or the second rate is not less than the first rate, switch to the second network for the second network to perform data transmission; and the second switching module 35 is configured to, after selecting the second network to perform data transmission, when the second rate is less than the threshold and the second rate is less than the first rate, switch to the first network for the first network to perform data transmission.

In practical applications, the device or system device provided by the present document can serve as a separate system, and it can also be a logic unit added in the existing mobile terminals such as a mobile phone for completing different functions.

When the logic unit is added in the mobile phone, the setting module 31, the detection module 32, the selection module 33, the first switching module 34 and the second switching module 35 can be implemented by a Central Processing Unit (CPU), a Digital Signal Processor (DSP) or a Field Programmable Gate Array (FPGA) located in the mobile phone.

The above description is only the preferred embodiments of the present document, which is not used to limit the protection scope of the present document.

### INDUSTRIAL APPLICABILITY

The embodiment of the present document provides a method for controlling a network connection, in the method, a threshold is set and it is a network rate threshold; in a case where at least two networks are simultaneously connected, a network rate of data transmission performed by each network is detected in real time; the detected network rate is compared with the threshold as a reference basis to obtain a comparison result; and a target network is selected from the at least two networks according to the comparison result and data transmission is performed; thus a network connection for performing data transmission is automatically selected with the existing data resources, which improves the users' data service experience.

What we claim is:

1. A method for controlling data transmission, comprising:
setting a threshold, wherein the threshold is a network rate threshold;
in a case that at least two networks are simultaneously connected, detecting a network rate of data transmission performed by each network in real time;
comparing the detected network rate with the threshold as a reference basis to obtain a comparison result; and
selecting a target network from the at least two networks according to the comparison result and performing data transmission.

2. The method according to claim 1, wherein said selecting a target network from the at least two networks according to the comparison result and performing data transmission comprises:
when there are two networks, acquiring a first rate corresponding to a first network and a second rate corresponding to a second network; and
when the second rate is less than the threshold and the second rate is less than the first rate, selecting the first network to perform data transmission.

3. The method according to claim 2, wherein selecting a target network from the at least two networks according to the comparison result and performing data transmission further comprises:
when the second rate is not less than the threshold or the second rate is not less than the first rate, selecting the second network to perform data transmission.

4. The method according to claim 2, further comprising:
after selecting the first network to perform data transmission, when the second rate is not less than the threshold or the second rate is not less than the first rate, switching to the second network for the second network to perform data transmission.

5. The method according to claim 3, further comprising:
after selecting the second network to perform data transmission, when the second rate is less than the threshold and the second rate is less than the first rate, switching to the first network for the first network to perform data transmission.

6. A device for controlling data transmission, comprising: a setting module, a detection module and a selection module; wherein, the setting module is configured to set a threshold, wherein the threshold is a network rate threshold;
the detection module is configured to, in a case that at least two networks are simultaneously connected, detect a network rate of data transmission performed by each network in real time; and
the selection module is configured to compare the detected network rate with the threshold as a reference basis to obtain a comparison result; and select a target network from the at least two networks according to the comparison result and perform data transmission.

7. The device according to claim 6, wherein a detection submodule is configured to, when there are two networks, acquire a first rate corresponding to a first network and a second rate corresponding to a second network;
correspondingly, the selection module comprises a first selection submodule configured to, when the second rate is less than the threshold and the second rate is less than the first rate, select the first network to perform data transmission.

8. The device according to claim 7, wherein the selection module further comprises a second selection submodule configured to, when the second rate is not less than the threshold or the second rate is not less than the first rate, select the second network to perform data transmission.

9. The device according to claim 7, wherein the device further comprises a first switching module configured to, after selecting the first network to perform data transmission, when the second rate is not less than the threshold or the second rate is not less than the first rate, switch to the second network for the second network to perform data transmission.

10. The device according to claim 8, wherein the device further comprises a second switching module configured to, after selecting the second network to perform data transmission, when the second rate is less than the threshold and the second rate is less than the first rate, switch to the first network for the first network to perform data transmission.
